(19) United States
(12) Patent Application Publication
(10) Pub. No.: US 2026/0066719 A1
(43) Pub. Date: Mar. 5, 2026

(54) IMPROVED LINEAR ACTUATOR

(71) Applicant: TETHR LIMITED, Hong Kong (HK)

(72) Inventors: Nikola Tomislav V NIKOLICH, LONDON (GB); Jensen LAI, Madison, CT (US)

(21) Appl. No.: 19/106,931

(22) PCT Filed: Aug. 31, 2023
(86) PCT No.: PCT/CN2023/116369

§ 371 Date: Feb. 26, 2025

(30) Foreign Application Priority Data
Aug. 31, 2022 (GB) 2212619.7

(51) Int. Cl. H02K 1/17; H02K 41/02

(52) U.S. Cl. CPC H02K 1/17; H02K 41/02

(57) ABSTRACT

This disclosure relates to a permanent magnet assembly and non-commutated linear actuator. There is provided a permanent magnet assembly for a non-commutated linear actuator, the permanent magnet assembly comprising: a magnetic core structure, and a permanent magnet having a first pole and a second pole, wherein the magnetic core structure comprises a central core portion connected to the first pole of the permanent magnet, an outer hollow portion connected to the second pole of the permanent magnet, and a gap region positioned between the central core portion and the outer hollow portion, wherein the magnetic core structure is configured such that magnetic flux generated by the permanent magnet flows between the central core portion and the outer hollow portion via the gap region, and wherein the magnetic core structure comprises one or more protrusions extending into the gap region.

### TECHNICAL FIELD

This invention relates to non-commutated linear actuators, and in particular, to permanent magnet assemblies for use in such motors.

### BACKGROUND

Linear motors, such as non-commutated linear actuators, are known. The noncommutated linear actuator (also referred to as a voice coil linear actuator, or a noncommutated DC linear actuator, when a DC signal is applied) is a direct drive linear actuator. It consists of a permanent magnet assembly and a coil assembly, and is arranged such that the current flowing through the coil assembly interacts with the permanent magnetic field generated by the permanent magnet assembly so as to generate a force vector perpendicular to the direction of the current. This force “actuates” the linear actuator, allowing for movement of the coil assembly in a linear fashion along a longitudinal axis.

Typical non-commutated linear actuators suffer from a number of drawbacks. Firstly, the interaction between the current flowing in the coil assembly and the permanent magnetic field can result in varying forces when a movable component in the actuator is at different positions along the length of movement. This requires an increased complexity in motor control so as to compensate for these differences in force, and to ensure consistent functionality across the linear movement.

Furthermore, as these devices rely on an alignment of a movable component that translates relative to a stationary component, the alignment between the movable component and the stationary component is critical to achieve the desired forces. Typical non-commutated linear actuators, however, suffer from poor protection from external forces, such as a mechanical shock, leading to misalignment between the stationary and movable components. Finally, when the coil assembly of the non-commutated linear actuator is part of the movable component in the actuator, there is a further issue with reliability regarding the electrical connection to this coil assembly. For example, where wires are used to connect to the coil assembly, regular movement of the movable component can lead to quick wear on the wires, resulting in failure of the motor.

In addition, typical non-commutated linear actuators suffer from high amounts of distortion and shifting of the magnetic flux lines within the air gap during high-load conditions (i.e., a high amount of current present in the coil assembly). Such distortion and shifting results in poor linearity of the control of the motor, less available force to apply to the coil, worse frequency response of the armature, worse repeatability of armature position, and worse compliance (i.e., the degree to which an armature faithfully moves in proportion to the input power without bouncing).

It would therefore be desirable to provide arrangements for overcoming, or at least mitigating, the problems of conventional linear actuators.

### SUMMARY

In accordance with a first aspect of the present invention there is provided a permanent magnet assembly for a non-commutated linear actuator, the permanent magnet assembly comprising: a magnetic core structure, and a permanent magnet having a first pole and a second pole, wherein the magnetic core structure comprises a central core portion connected to the first pole of the permanent magnet, an outer hollow portion connected to the second pole of the permanent magnet, and a gap region positioned between the central core portion and the outer hollow portion, wherein the magnetic core structure is configured such that magnetic flux generated by the permanent magnet flows between the central core portion and the outer hollow portion via the gap region, and wherein the magnetic core structure comprises one or more protrusions extending into the gap region.

It may be understood that a magnetic core structure can refer to a mechanical structure having a high magnetic permeability (i.e., the internal dipoles of the material of the structure are easily oriented in response to an applied magnetic field), so as to confine and guide magnetic fields. In this case, the magnetic core structure is configured to confine and guide magnetic fields generated by the permanent magnet. It may be understood that a gap region may refer to one or more air gaps which are present between the outer hollow cylindrical portion and the central core portion.

The terms “central core” and “outer hollow” refer to the relative arrangement of these features. That is, the outer portion of the magnetic core structure may entirely surround and be concentric with the central core portion. Alternatively, the outer hollow portion may comprise two arms, one to cover a top portion of the central core and another to cover a bottom portion of the central core. The central core portion may have a substantially circular, ovular, square, rectangular, etc. cross-section. The outer hollow portion may similarly have a substantially circular, ovular, square, rectangular, etc. cross-section, but having a lack of material within its centre (so as to render the structure hollow). It is not, however, a requirement that the central core portion and outer hollow portion have similar crosssectional shapes. Nevertheless, in some embodiments, the outer hollow portion and the central core portion do have a similar cross-sectional shape (e.g., they may both have a substantially circular cross-section, and each have an overall cylindrical shape). For the avoidance of doubt, an “outer hollow portion” may refer to the same feature as a “outer polepiece” and a “central core portion”may refer to the same feature as an “inner pole-piece”.

It may also be understood that, because the outer hollow portion can be concentric with the central core portion, the two portions can share a cross-sectional centre point. It is also understood that a length of the outer hollow portion (as defined by a line along the surface of the outer hollow portion from a proximal end of the permanent magnet assembly to a distal end of the permanent magnet assembly) is substantially parallel to a corresponding length of the central core portion.

The proximal and distal terminology has been used to define the end points of the permanent magnet assembly. It may be understood that the central core portion and the outer hollow portion each extend between the respective proximal and distal ends. It may also be understood that the end of the permanent magnet assembly where the permanent magnet is positioned can be considered the proximal end.

It may also be understood that the permanent magnet assembly is designed so as to define a channel between a movable component in a non-commutated linear actuator (also known as a longitudinally-translatable component), and that this channel may comprise the gap region.

For the sake of completeness, a protrusion may refer to a feature of the magnetic core structure which juts out from, or extends from, a surface of the magnetic core structure. In this case, the one or more protrusions are configured to extend into the gap region, thereby shortening the distance between the outer hollow portion and the central core portion at least at the location of the one or more protrusions.

It may also be understood that a protrusion is a three-dimensional structure. Therefore, it can extend a fixed distance from the entirety of the surface (e.g., a flared ring-shaped disc extending outwardly from a cylindrical core portion). It may also be provided as a number of discrete, fixed protrusions which do not necessarily extend around a circumference of the core portion or outer portion.

One benefit of the above arrangement is that the one or more protrusions serve to shorten the distance between the outer hollow portion and the central core portion thereby intensifying the magnetic field which is present within the air gap, compared to an equivalent arrangement where no protrusions are present. This is advantageous because a higher density of magnetic field (i.e. magnetic flux) within the gap region means that more force can be transferred to an electrically conductive element present within the gap region (such as a wire-wound coil in a non-commutated linear actuator). This effect will arise without the need of increasing the strength or size of the permanent magnet, further improving the cost-effectiveness and size of such permanent magnet assemblies.

Another benefit is that the protrusions result in less distorted magnetic flux lines within the air gap, which are present at high-current loads on the coil. Less distortion and shifting on the magnetic flux in the air gap is advantageous because it improves the linearity of control (so that input power versus position of armature is improved).

Furthermore, by reducing the amount of distortion and shifting of the magnetic flux lines, there is more available force to apply to the coil, because of the higher flux density across the coil at a perpendicular direction to the current in the coil. It also ensures an improved frequency response of the armature, and better repeatability of armature position.

Finally, reducing the amount of distortion and shifting of the magnetic flux lines in the air gap leads to better compliance (i.e., the degree to which an armature faithfully moves in proportion to the input power without bouncing) of the linear actuator.

In some embodiments, the one or more protrusions of the magnetic core structure comprise one or more core protrusions, extending radially outwards from the central core portion into the gap region.

In some embodiments, the one or more protrusions of the magnetic core structure comprise one or more hollow portion protrusions, extending radially inwards from the outer hollow portion into the gap region.

It may be understood that the one or more core protrusions are features which are integral with, or attached to, the central core portion. It may also be understood that the one or more hollow portion protrusions are integral with, or attached to, the outer hollow portion.

One benefit of having a protrusion exclusively on one of the central core portion or the outer hollow portion is that the same benefits of increased magnetic flux can be achieved whist limiting the increase in complexity in costs and manufacturing. For example, as opposed to building protrusions onto both the central core and hollow outer portions (each of which would necessitate a distinct manufacturing process), a protrusion can be implemented solely on the outer hollow portion, allowing the central core portion to have a more simplified design (or vice versa).

In some embodiments, at least one core protrusion of the one or more core protrusions corresponds to, and is aligned with, a respective hollow portion protrusion of the one or more hollow portion protrusions.

It may be understood that when a core protrusion “corresponds to, and is aligned with,” a respective hollow portion protrusion, this refers to an arrangement where said core protrusion is positioned at a certain position along the length of the core portion and where said respective hollow portion protrusion is also positioned at the same position along the length of the hollow portion. In other words, it may be understood that these two protrusions extend toward each other, so as to further reduce the distance between the core portion and the outer hollow portion than would be achieved with a single protrusion having the same size.

Such an arrangement is particularly advantageous when it is desirable to optimize the magnetic flux present in the air gap, whilst also keeping the length of each protrusion to a minimum. In other words, having an equivalently shortened air gap (with corresponding protrusions from either side) means that each of the respective protrusions forming said air gap are smaller than a corresponding arrangement with a single, longer protrusion (extending from either the central core portion or the outer hollow portion). This results in a robust permanent magnet assembly (as shorter protrusions are less prone to breaking), and a significantly improved magnetic flux density as opposed to an arrangement without protrusions.

In some embodiments, the central core portion has an axial cross-section which is substantially circular, substantially ovular, or substantially square.

In some embodiments, the hollow portion has an axial cross-section is substantially circular, substantially ovular, or substantially square, and wherein the hollow portion comprises at least one elongated slot along its length, so as to allow access to the gap region.

It may be understood that the at least one elongated slot is an aperture that protrudes entirely through the thickness of the hollow portion. Such a slot is designed so as to allow electrical communication to a component which can be present in the gap region. This allows electrical power to be delivered to, e.g., a wire-wound coil present in the gap region to form a non-commutated linear actuator.

As noted above, the central core portion and hollow portion can each take distinct shapes, which are ultimately dictated by the shape of the linear actuator which the permanent magnet assembly is a part of. For example, where a movable component of a linear actuator is a hollow cylinder, it may be advantageous to provide both the central core portion and the outer hollow portion with substantially circular axial cross sections, so as to provide a ring-shaped gap region that the movable component sits within.

One advantage of designing the permanent magnet assembly in this way (i.e., with an elongated slot in the outer hollow portion) is to maximize the magnetic flux generated between the outer hollow portion and the core portion, since the magnetic flux is transferred along the length of the permanent magnet assembly except for the portion of the elongated slot.

In some embodiments, the one or more core protrusions has an axial cross-section which substantially circular, substantially ovular, or substantially square.

In some embodiments, the one or more hollow portion protrusions has an axial cross-section is substantially circular, substantially ovular, or substantially square, and wherein the hollow portion protrusion comprises at least one elongated slot along its length, so as to allow access to the gap region.

As noted above, a protrusion is a three-dimensional structure. Therefore, it can extend a fixed distance from the entirety of the surface (e.g., a flared ring-shaped disc extending outwardly from a cylindrical core portion). The above arrangements define that the protrusions can have substantially circular, ovular, or square cross sections. This may refer to a cross-section defined by the outer-most or inner-most edge of the protrusion. For example, with a cylindrical core, and a ring-shaped disc extending outwardly from a point along the length of the core, the ring-shaped disc protrusion could be considered to have a substantially circular cross-section. This is because the outer-most edge of this disc is circular.

In this instance, the axial cross-section of the protrusion may refer to the crosssection of the protrusion and the core portion itself. For example, a protrusion of constant length extending from a cylindrical core portion may be considered to have a circular cross section.

Alternatively, the axial cross-section of the protrusion may refer to the cross section of solely the protrusion (in absence of the core portion). In this way, it can also be considered that the cross-section of such a core protrusion is ring-shaped (as opposed to circular).

It may be understood that the elongated slot of the hollow portion protrusion is aligned with the corresponding elongated slot of the hollow portion. This is because there is a lack of magnetically-permeable material in the elongated slot of the hollow portion, and therefore, nothing can protrude from this feature.

In some embodiments, the one or more core protrusions comprises a plurality of core protrusions, and/or the one or more hollow portion protrusions comprises a plurality of hollow portion protrusions.

One benefit of a plurality of core protrusions and/or hollow portion protrusions is that the regions of increased magnetic flux can be distributed across the length of the permanent magnet assembly. For example, where a first core protrusion is present at a first location along the length of the magnetic core structure and where a second core protrusion is present at a second location along the length of the magnetic core structure (the second location being positioned distally or proximally to the first location), this provides at least two distinct regions of increased magnetic flux within the gap region. The distribution of these protrusions (and therefore the regions of increased magnetic flux) improves the operation of a non-commutated linear actuator which implements such a permanent magnet assembly. This is because a movable component in the linear actuator would experience more even magnetic flux across the possible length of travel of the movable component.

In some embodiments, each of the plurality of the core protrusions is separated from adjacent core protrusions by a second distance, and each of the plurality of hollow portion protrusions is separated from adjacent hollow portion protrusions by the second distance.

It may be advantageous for the core protrusions to each be separated by a fixed distance from one another. The same is true of the hollow portion protrusions. This is because a fixed distance further ensures that a movable component of a non-commutated linear actuator experiences uniform forces acting upon it across the possible length of travel of the movable component.

In some embodiments, the second distance may be a shorter length than the length of an associated movable component of a non-commutated linear actuator. When this is the case, there is no position along the length of travel of the movable component where the movable component would not be present in a region of increased magnetic flux (formed by the aforementioned protrusions).

In some embodiments, the permanent magnet assembly further comprises a filler material positioned so as to cover side portions of the one or more protrusions.

It may be understood that a “side portion” of a protrusion refers to an edge or area which is facing in a substantially proximal or distal direction (i.e., facing towards the proximal direction or distal direction of the magnetic core structure). When multiple protrusions are present on the same portion of the magnetic core structure (e.g., the core portion), the “side portions” of the two protrusions are the portions of each which face each other. In other words, the side portion is the part of each protrusion which does not form the base of the protrusion or which does not face the associated gap region.

“Cover” may refer to a feature which entirely covers the side portion of the protrusion. Alternatively, only a select part of the side portion of the protrusion can be covered).

The benefit of introducing a material to cover a side portion of a protrusion is to prevent the protrusion from having a sharp edge. Sharp edges are not desirable, particularly when a movable component is travelling within a gap region. By providing a filler material, any sharp corners associated with the protrusion can be rounded off. As a result, if a noncommutated linear actuator having such a permanent magnet experiences any external forces (e.g., a drop, or a chassis of the linear actuator being hit), then a movable component of said linear actuator would not hit a sharp corner during its motion. In other words, the permanent magnet assembly of this embodiment provides all of the benefits associated with increased magnetic flux at certain points along the magnetic core structure, but it is one that does not worsen the structural resilience of an associated linear actuator.

In some embodiments, the filler material is configured to entirely fill a space between adjacent core protrusions of the plurality of core protrusions, and the filler material is configured to entirely fill a space between adjacent outer hollow portion protrusions of the plurality of hollow portion protrusions.

It may be understood that “adjacent” refers to two protrusions which are near each other, with no intervening protrusion. Thus, when the filler material entirely fills the space between them, each of the side portions of the adjacent protrusions are entirely covered. Moreover, by entirely filling the space between the protrusions, this means that the channel in which the movable component of the linear actuator travels is uniform across the entire length of the permanent magnet assembly. In this way, the channel is solely defined by the gap between the axial cross section of the core protrusions (or if not present, the surface of the core portion) and the axial cross section of the hollow portion protrusions (or if not present, the surface of the outer hollow portion).

The benefit of having a uniform profile of the channel/gap region is that an improved structural integrity can be realized. Further, as noted above, any reduction in edges along the length of the permanent magnet assembly is beneficial for shock-resistance, as a movable component cannot get as easily damaged coming into contact with a flat surface. This also helps brings the movable component back into alignment, as the uniform channel formed by the filler material can limit the allowable movement of the movable component, thereby preventing it from getting jammed.

In some embodiments, the filler material comprises a resin.

The filler material may be any material which is relatively magnetically impermeable relative to the permeability of the core portion, hollow portion, and associated protrusions. This means that the filler material will have a negligible effect on the magnetic field which is provided within and directed through the magnetic core structure. It is also advantageous to provide a material with a low coefficient of friction, so as to not impact negatively upon a movable component present within the channel formed at least partially by the filler material.

There is also provided, according to the present invention, a non-commutated linear actuator having a stationary component and a movable component, the movable component configured to move in a longitudinal direction relative to the stationary component, wherein the stationary component comprises a permanent magnet assembly according to any of the above embodiments, and wherein the movable component is positioned within the air gap region of the permanent magnet assembly.

It may be understood that a non-commutated linear actuator is also referred to as a voice coil linear actuator (or a non-commutated DC linear actuator, when a DC signal is applied) and is a direct drive linear actuator. It consists of a permanent magnetic assembly and a movable component, which is configured to interact with the permanent magnetic field generated by the permanent magnetic field assembly so as to generate a force vector perpendicular to the direction of the current.

It may be understood that the movable component is also referred to herein as a longitudinally-translatable component.

In some embodiments, the movable component comprises at least one conductive winding.

It may be understood that the movable component is provided with a conductive winding so that current can be driven along the path of the winding, so that the current flowing through the coil assembly interacts with the permanent magnet assembly.

In some embodiments, the movable component comprises a structure comprising at least one of a carbon fiber, a thermoplastic, a thermoset plastic, or a synthetic fiber material, and wherein the at least one conductive winding is wound around the structure.

The tube can be formed out of a number of insulating materials, including, e.g., carbon fiber, PEEK, PEKK, or any other type of insulative polymer. It can also be formed out of a synthetic fiber material, such as Kevlar.

Winding the at least one conductive winding around the structure can increase the current density around the circumference of the structure, which results in a stronger interaction between an input current and the magnetic flux generated by the permanent magnet assembly.

In some embodiments, the structure is tubular, so as to fit within a cylindrical linear actuator. However, the structure can take any appropriate shape (e.g., a hollow rectangular prism) so as to fit the profile of the specific linear actuator.

In some embodiments, the non-commutated linear actuator further comprises an electrical interface configured to connect the at least one conductive winding to an electrical power supply through the at least one elongated slot.

The electrical interface of the present invention may be any connection (such as a direct wired connection) to the at least one conductive winding.

In some embodiments, the electrical interface comprises at least one flexible conductive band configured to transmit electrical power from the electrical power supply to the at least one conductive winding on the movable component.

A “flexible conductive band” may refer to a strip, or loop, of material. The band itself may be at least partially formed out of a conductive material, or there may be conductive elements positioned on, around, or connected to a non-conductive substrate of the band. It may be also understood that “flexible” refers to a capacity for the conductive band to bend or deform without breaking.

In some embodiments, the flexible conductive band is an elastic element that can be deformed (e.g., compressed) from a resting state to an assembled state, when positioned between the first and second conductive surfaces. The flexible conductive band in such an assembled state can be under a mechanical strain, whereby the flexible conductive band is being urged back to its resting state. Such a property can allow for improved electrical connection between the first and second conductive portions, as the surface area of electrical contact is maximised.

In some embodiments, the at least one flexible conductive band is configured to interact mechanically with a first contact area and interact mechanically with a second contact area. Here the first area may be a conductive strip on the movable component, and the second area may be a conductive strip coupled to a chassis of the non-commutated linear actuator. As a result, when the second portion is moved relative to the first portion the flexible conductive band is configured to travel in a predefined path and maintain electrical connection between the first contact area and the second contact area.

In some embodiments, to travel in the predefined path, the at least one flexible conductive band is configured to move in a rolling motion as the movable component of the linear actuator is translated.

In such an embodiment, the at least one flexible conductive band is configured to transmit the electrical power to the at least one conductive winding on the longitudinally translatable, or movable, component.

Such an arrangement can replace wired connections to a conductive winding on the longitudinally translatable, or movable, component. These wires can experience a high amount of stress over iterations of the linear motor being fired. Therefore, the linear electric motor of the present invention is advantageous in that component wear is reduced, and the longevity of the motor itself can be increased.

### BRIEF DESCRIPTION OF DRAWINGS

Advantageous embodiments of the present invention will now be described with reference to the accompanying drawings, wherein:

FIGS. 1A and 1B are exemplary linear actuators with smooth-faced faces of the permanent magnet assembly.

FIG. 2 is an isometric view of a cylindrical linear actuator, according to an embodiment of the invention.

FIG. 3 is an exploded view of the cylindrical linear actuator shown in FIG. 1.

FIG. 4 is a sectioned view of the cylindrical linear actuator shown in FIG. 1.

FIG. 5 is a cross sectional 2D-view of a permanent magnet assembly according to an embodiment of the invention, and illustrates magnetic flux present in the permanent magnet assembly.

FIGS. 6A and 6B are 3D views of an outer hollow portion for use with a permanent magnet assembly according to an embodiment of the invention.

FIG. 7 is a 3D-view of a permanent magnet assembly according to an embodiment of the invention, where the permanent magnet assembly is installed in a linear actuator.

FIG. 8 is an isometric view of a rectangular linear actuator, according to an embodiment of the invention.

FIGS. 9 and 9A show a sectioned view of the rectangular linear actuator of FIG. 8, as well as a sub-section view with the magnetic flux lines shown.

FIG. 10 is an illustration of an exemplary flexible conductive band, for use in a linear actuator according to an embodiment of the invention.

FIG. 11 is another illustration of the flexible conductive band shown in FIG. 7.

### DESCRIPTION OF EMBODIMENTS

In the below description, the terms “first”, “second”, “primary”, and “secondary” are not intended to be limiting, but are rather used to distinguish different elements from each other. The longitudinal axis of the linear actuator can be considered an axis running in a direction between the proximal end (i.e., the power input side) and the distal end of the electrical motor. In other words, this longitudinal axis follows the direction of travel of the motor.

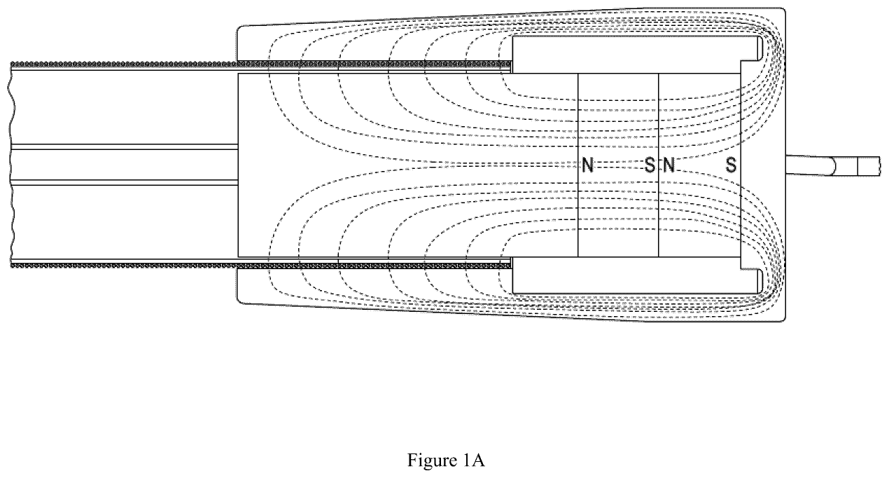

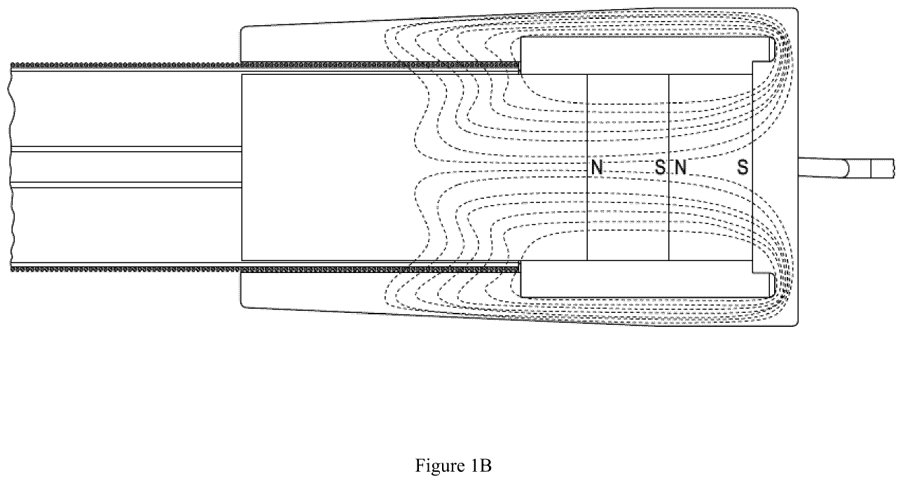

FIGS. 1A and 1B depict a phenomenon relating to cylindrical linear actuators of an appreciable length comprising a permanent magnet assembly having an inner pole-piece and an outer pole-piece. As can be seen in FIG. 1A, magnetic flux lines (the dashed lines) emerge from the permanent magnets and pass from the outer pole-piece of the permanent magnet assembly, across an air gap, and into an inner pole-piece of the permanent magnet assembly, closing the magnetic circuit at the other terminal of the permanent magnets. In this case, the faces of both the outer pole-piece and inner pole-piece in the region of the air gap are smooth, and have no salient features protruding into the air gap. The magnetic field present through the air gap is configured to interact with a current flowing within a coil layer (which is present within the air gap), so as to generate a linear force on the coil layer.

FIG. 1B depicts the magnetic flux lines of the linear actuator of FIG. 1A under heavy loading conditions (i.e., when a high current is passed through the coil of the coil layer). In this case, the magnetic flux lines (again, shown with dashed lines) become distorted and shifted within the air gap where they intersect with the coil of the coil layer. In the depicted example, the magnetic flux lines are shifted backwards, however it is understood that the magnetic flux lines would be shifted forwards if the polarity of the current in the coil were to be reversed.

This phenomenon is an equivalent in linear actuators for armature reaction in DC rotary machines that have either permanent magnets or electromagnets to generate field flux. That is, in a rotary machine, the Geometric Magnetic Neutral Axis (GMNA) experiences a secondary magnetic field produced by the armature (armature flux) and these two magnetic fields interact (determined by the Electrical Neutral Axis ENA) such that a rotary torque is produced when the angle between them is 90 degrees or less.

As noted above, the actuator of FIGS. 1A and 1B has a permanent magnet assembly where both the inner pole-piece nor the outer pole-piece are substantially smooth along their surfaces in the region of the air gap.

As a result, the actuator depicted in FIGS. 1A and 1B has significant issues related to motor control. Specifically, the distorted magnetic flux lines within the air gap are disadvantageous because they lead to worse linearity of control, less available force to apply to the coil, worse frequency response of the armature, worse repeatability of armature position, and worse compliance (i.e., the degree to which an armature faithfully moves in proportion to the input power without bouncing).

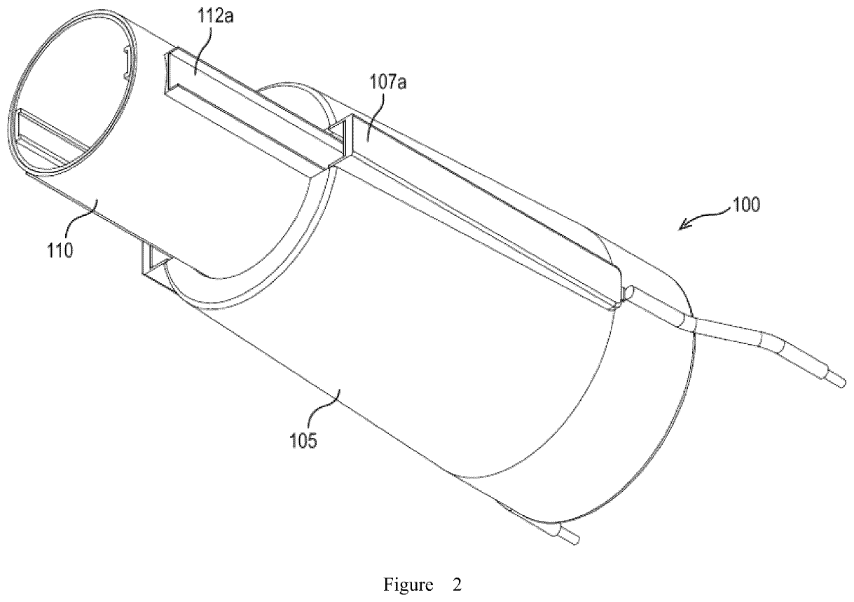

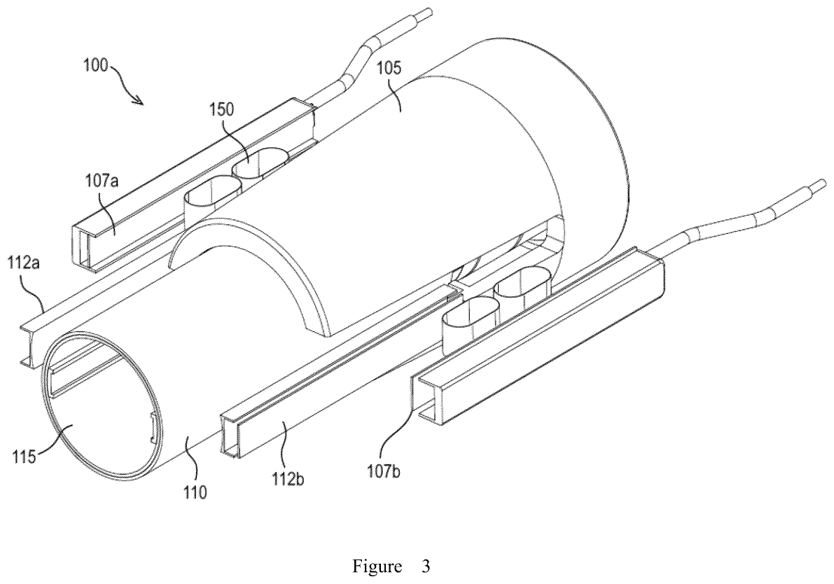

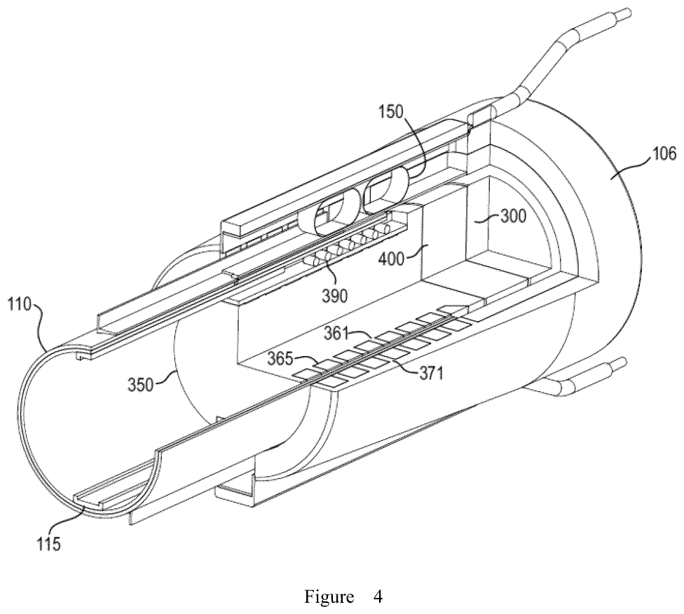

A first embodiment of a cylindrical linear actuator 100 is shown in FIGS. 2 to 4. FIG. 2 shows an isometric view of the assembled linear actuator 100, whilst FIG. 3 shows an exploded view of the linear actuator 100, and FIG. 4 shows a sectioned view of the linear actuator 100 to provide further detail on the internal componentry.

The cylindrical linear actuator 100 includes a stationary component 105 and a movable component 110. In operation, electrical power (e.g., electric current) is delivered to the movable component 110 from the stationary component 105. In the embodiment shown, current will flow around the surface of the movable component 110 and interact with a permanent magnetic field which is present within the linear actuator 100 so as to generate a force vector. In this way, the linear actuator can be considered a type of non-commutated linear actuator (which may also be referred to colloquially as “voice coil” motors).

Such a linear actuator can be operated bidirectionally, by adjusting the polarity of the input voltage/current applied at the input terminals of the linear actuator.

As such a linear actuator 100 requires current flow to be present on the movable component 110, there is a mechanism for delivering the input voltage/current from the input terminals of the linear actuator 100 to the movable component 110. This can be achieved with any number of interface elements, as would be understood by a skilled person.

In one embodiment of the invention, the electrical interface of the linear actuator 100 (i.e., the electrical interface between the stationary and movable components) is provided via one or more flexible conductive bands 150. The one or more flexible conductive bands 150 are configured to deliver current from a stationary power rail 107 (a power rail fixed to the stationary component 105 of the linear actuator 100) to a movable power rail 112 (a power rail fixedly mounted onto the movable component 110 of the linear actuator 100).

In some cases, there is a first electrical interface formed by a first set of flexible conductive bands, a first stationary power rail 107a, and a first movable power rail 112a. The first set of flexible conductive bands is configured to deliver a first electrical signal between the first stationary power rail 107a and the first movable power rail 112a. There may be a plurality of flexible conductive bands 150 so as to ensure appropriate power can be delivered to the movable component 110, and to ensure that current is being delivered more uniformly to the movable component 110 across the length of the movable component 110.

In some instances, there is a second electrical interface formed by a second set of flexible conductive bands, a second stationary power rail 107b, and a second movable power rail 112b. The second set of flexible conductive bands 150 is configured to a second electrical signal between the second stationary power rail 107b and the second movable power rail 112b. There may also be a plurality of flexible conductive bands 150 so as to ensure appropriate power can be delivered to the movable component 110, and to ensure that current is being delivered more uniformly to the movable component 110 across the length of the movable component 110.

In such cases, the first and second electrical interfaces are provided to deliver a bipolar electric signal to the movable component 110. That is, the second electrical interface serves as a return path for the signal delivered across the first electrical interface. In other words, when a power supply is connected to the two input terminals of the linear actuator 100, current will flow from the power supply, through the first electrical interface, around the surface of the movable component 110, and exit through the second electrical interface to return to the power supply.

In some embodiments, there is at least one conductive winding (not shown) on the movable component 110, which may be wound around the structure of the movable component 110. The act of winding a conductive winding around the movable component 110 means that more force can be generated by the linear actuator without needing to increase the voltage of the power supply. As noted above, current flowing through the coil assembly interacts with the permanent magnetic field generated by the permanent magnet assembly so as to generate a force vector perpendicular to the direction of the current.

Additional loops of a conductive windings will increase the current density around the movable component 110, thereby increasing the force experienced by the linear actuator 100 due to the interaction with the permanent magnetic field. However, the linear actuator 100 will also operate should the current flow around the surface of the movable component 110 without multiple loops present.

As shown in FIG. 3, the first and second electrical interfaces may be on opposite sides of the linear actuator 100. However, other arrangements are also possible (including, e.g., the first and second electrical interfaces being adjacent on the same side of the linear actuator 100).

The one or more flexible conductive bands 150 provide a low-friction electrical interface between the stationary and movable components in the linear actuator 100. When the movable component 110 is translated along the longitudinal axis, the one or more flexible conductive bands 150 are configured to move in a rolling fashion in the same direction as the movable component 110. This type of interface provides a lower friction interface than corresponding static interfaces, and it is less prone to wear than electrical interfaces that utilize brushes or direct wiring arrangements.

Such an electrical interface may therefore be considered an improved electrical commutation assembly, which provides a high current capacity, high resilience to wear, and low friction, all of which make the electrical interface particularly advantageous for delivering electrical signals to an electrical motor assembly.

As noted above, the cylindrical linear actuator 100 according to an embodiment of the invention includes a permanent magnet assembly 300 for generating a constant permanent magnetic field.

The permanent magnetic field is generated by a permanent magnet assembly 300, which is located within a chassis 106 of the stationary component 105. For the avoidance of doubt, the permanent magnet assembly 300 is not visible in FIGS. 2 and 3, but it can be seen in the sectioned view of FIG. 4.

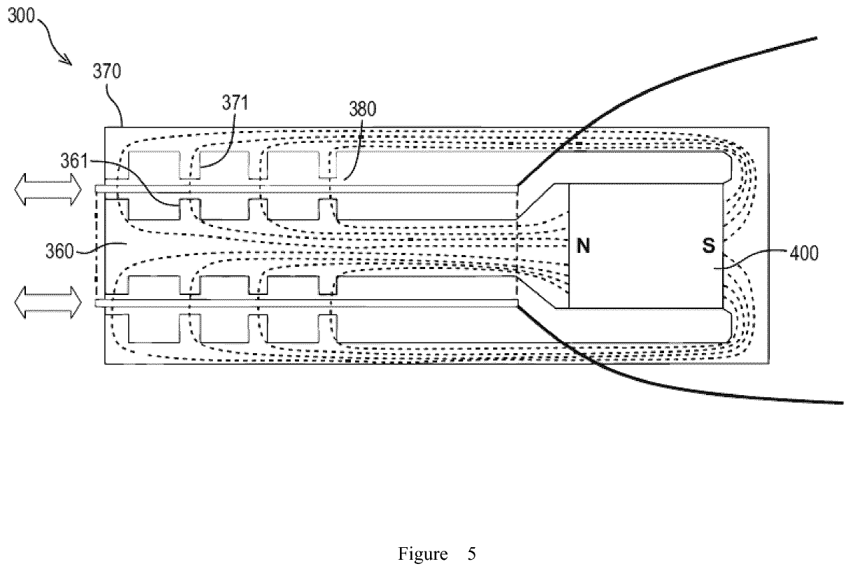

With reference to FIGS. 4 and 5, the permanent magnet assembly 300 includes a permanent magnet 400 having a first pole (e.g., a North pole) and a second pole (e.g., a South pole), as well as a magnetic core structure 350.

In some embodiments, the magnetic core structure 350 is made from a material having a high magnetic permeability, so as to confine and guide magnetic fields generated by the permanent magnet 400. In some embodiments, the magnetic core structure 350 may comprise a ferromagnetic material such as iron, other ferrimagnetic compounds, or silicon. The core structure may or may not be laminated.

The magnetic core structure 350 includes two portions: a central core portion 360, and an outer hollow portion 370. In the cylindrical embodiment of the linear actuator 100 shown in FIG. 4, the outer hollow portion 370 has a generally ring-shaped cross-section, and the central core portion 360 has a generally circular cross section.

The cross section of the outer hollow portion 370 may have at least one elongated slot 375 along a portion of the length of the permanent magnet assembly 300, so as to accommodate the electrical interface.

As is best seen in the embodiment of FIG. 2, there may be two elongated slots 375, aligned with the two electrical interfaces. As a result, the cross-section of the outer hollow portion 370 in FIG. 2 is generally ring-shaped, with a removal of material on a first side of the ring, and on a second, opposite side of the ring. The removal of material forms the elongated slots 375 in the outer hollow portion 370, which allows power to be delivered to a movable component 110 positioned generally within the outer hollow portion 370.

The central core portion 360 is coupled to the first pole of the permanent magnet 400, whilst the outer hollow portion 370 is coupled to the second pole of the permanent magnet 400.

As is best seen in FIG. 5, the central core portion 360 is separated from the outer hollow portion 370 by a gap region 380. The gap region 380 has sufficient width so that, when the permanent magnet assembly 300 is installed in a linear actuator 100, at least a portion of the movable component 110 of the linear actuator 100 can sit within the gap region 380.

In other words, it is understood that this gap region 380 defines a channel along the length of the permanent magnet assembly (and therefore along the length of the associated linear actuator), and the movable component is configured to move within this channel.

As shown in FIG. 5, the magnetic field travels from the north pole of the permanent magnet 400 to the south pole of the permanent magnet 400 through the magnetic core structure 350. The magnetic field travels between the central core portion 360 and the outer hollow portion 370 through the gap region 380.

As a result of the protrusions, whilst there may some minimal amount of local distortion of the magnetic flux lines in response to high-current conditions in the coil, the shifting of the magnetic flux lines along the length of the hollow outer portion and central core portion (such as the shifting seen in FIGS. 1A and 1B) is substantially avoided.

In other instances, the permanent magnet 400 can be connected in an opposite orientation (i.e., the north pole being connected to the outer hollow portion 370 and the south pole being connected to the central core portion 360). Such an arrangement does not affect operation of the linear actuator 100, although reverse polarity of the power supply is necessary for providing an equivalent control. This is because applying the same voltage to a linear actuator 100 will either result in the movable component 110 moving distally or proximally, depending on the orientation of the magnet.

The permanent magnet 400 may be any one of the following types: alnico (AlNiCo), ferrite, samarium cobalt (SmCo), flexible rubber, or neodymium magnet, also known as a neodymium iron boron magnet (NdFeB). In some embodiments, the permanent magnet is a neodymium iron boron (NdFeB) permanent magnet, which may have an axial magnetisation.

In some embodiments, the permanent magnet may be cylindrically shaped, with a width of approximately 5-40 mm (preferably 15 mm) and a diameter of approximately 20-40 mm (preferably 31.5 mm).

In some embodiments, the flux density at the face of the permanent magnet 400 may be approximately 0.1-2 Tesla (preferably 1.7 Tesla).

In the embodiment shown in FIG. 4, the movable component 110 has the shape of a hollow tube, surrounds the central core portion 360 (which is generally cylindrical), and is surrounded by the outer hollow portion 370 (which is generally the shape of a hollow cylindrical tube).

To further improve performance of the linear actuator 100, the magnetic core structure 350 may comprise one or more protrusions 361, 371 extending into the gap region 380. These protrusions 361, 371 serve to shorten the distance between the central core portion 360 and the outer hollow portion 370, thereby increasing the magnetic flux density in the air gap.

In the embodiments shown in FIGS. 4 and 5, there are a plurality of protrusions 361 along the length of the central core portion 360, and a corresponding plurality of protrusions along the length of the outer hollow portion 371.

As shown in FIG. 5, the vast majority of the magnetic flux in the gap region 380 is present between the corresponding teeth-like protrusions 361, 371. In this embodiment, such protrusions 361, 371 provide regions of increased magnetic flux at regular intervals across the length of the permanent magnet assembly 300.

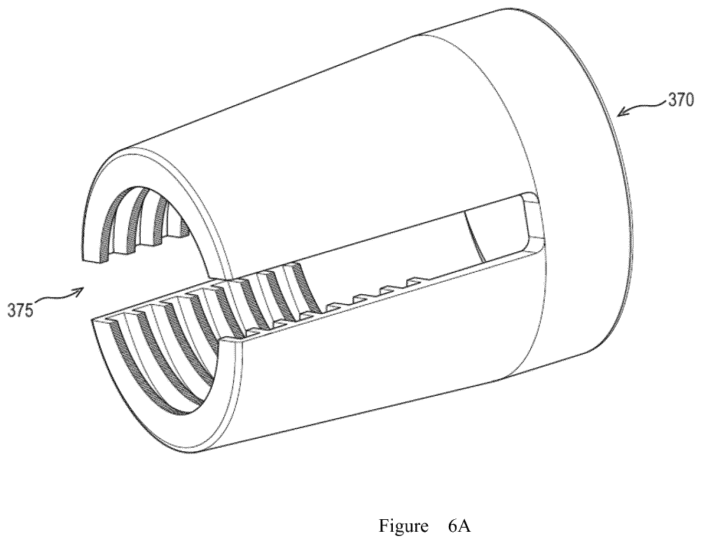

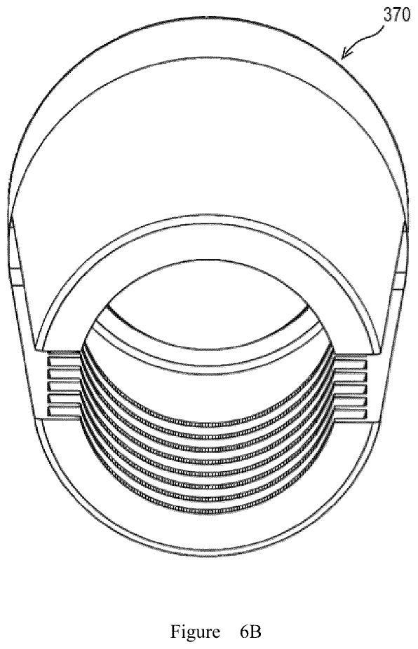

In the cylindrical linear actuator 100 of FIG. 4, it can be seen that each of the protrusions 361 extends around the circumference of the central core portion 360. In other words, each protrusion 361 extending from the central core portion 360 (i.e., core protrusions) has a generally ring-shaped cross-section (or alternatively, the cross-section of the protrusion and the underlying central core portion 360 is circular). The corresponding protrusions 371 extending from the outer hollow portion 370 (i.e., hollow portion protrusions) each also have a generally ring-shaped cross-section. For further detail, one embodiment of an outer hollow portion 370 is depicted in FIGS. 6A and 6B.

In the embodiment of FIG. 4, there is a cavity between each of the adjacent core protrusions 361, and a similar cavity between each of the adjacent hollow portion protrusions 371. These cavities can best be seen in the cross-section shown in FIG. 5.

In some embodiments, the width of the teeth-like protrusions can be approximately 1 to 10 mm (preferably 2 mm).

In some embodiments, as shown in FIG. 4, these cavities are each filled with a filler material 365, which may be a resin. In FIG. 4, the cavities are entirely filled, so that the gap region has a uniform width across the length of the permanent magnet assembly (and so the channel for the movable component of the associated linear actuator does not have any corners).

As noted above, it is beneficial to have a uniform profile of the channel/gap region 380, to prevent sharp edges that might interfere with the movable component 110 of the linear actuator 100. This is particularly beneficial for improving shock-resistance, as a movable component 110 cannot get as easily damaged coming into contact with a flat surface, and it also helps brings the movable component 110 back into alignment, as the uniform channel formed by the filler material 365 can limit the allowable movement of the movable component 110, thereby preventing it from getting jammed.

As is seen in FIGS. 2 to 4 and 7, in some embodiments there is a guide rail 115 mounted on an inside surface of the movable component 110. In some embodiments, there may be a plurality of guide rails 115, e.g., one rail on either side of the movable component 110.

In the embodiment of FIGS. 2 to 4, there is a first guide rail 115a mounted on one side of the interior of the movable component and a second guide rail 115b mounted on the opposite side of the interior of the movable component 110. In this embodiment, the guide rails are aligned with the elongated slots 375 of the outer hollow portion 370 (so as to minimize the losses in magnetic flux along the length of the movable component 110), although this is not strictly necessary. Where the guide rail is present, the central core portion 360 has one or more cut-outs, so as to accommodate the guide rails 115.

The purpose of the guide rails 115 is to improve the sliding mechanics of the linear actuator 100. In some embodiments, the guide rail 115 may slide over ball bearings or rollers 390. Such rollers 390, which can be made out of a low friction material (such as PEEK) are shown in FIG. 4.

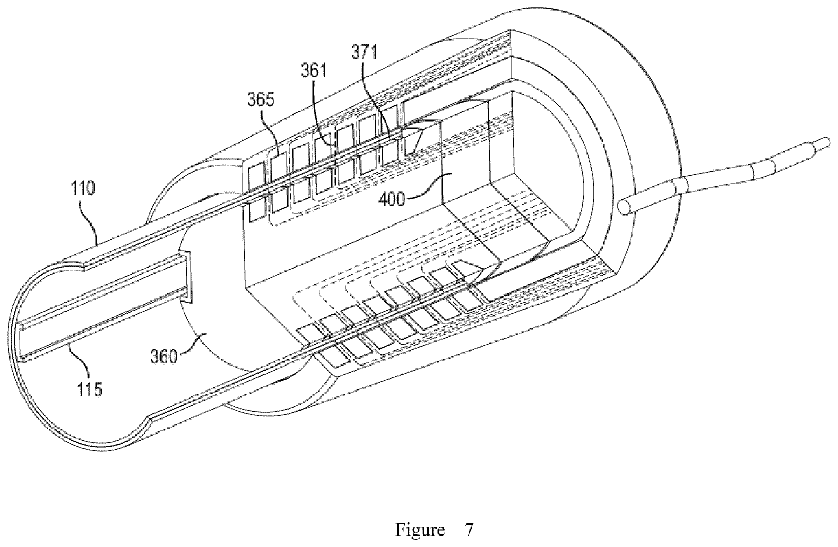

FIG. 7 illustrates an alternative isometric view of the cylindrical linear actuator 100 of FIGS. 2 to 4. In this figure, the electrical interface has been hidden, and the view is rotated so as to emphasize the guide rail 115 on the inside of the movable component 110, and the corresponding notch in the central core portion 360 of the permanent magnet assembly 300.

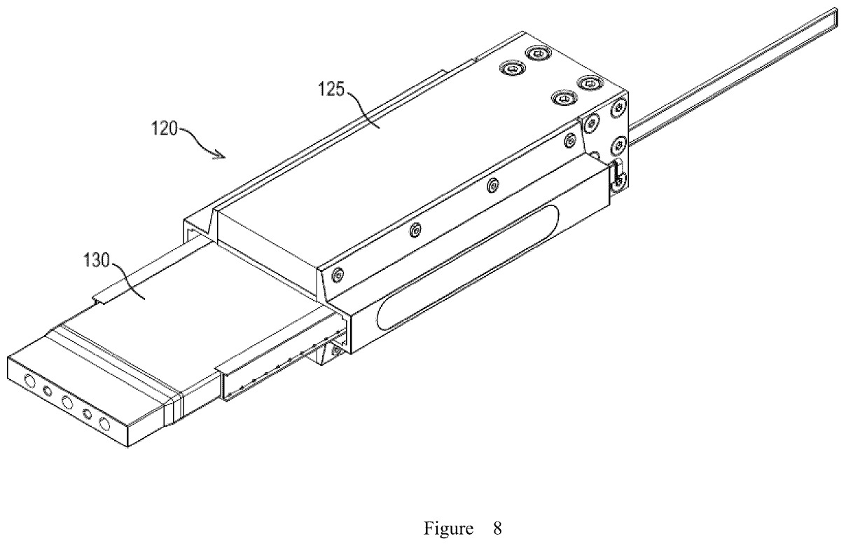

FIG. 8 depicts an isometric view of a rectangular linear actuator 120, according to another embodiment of the invention. The rectangular linear actuator 120 includes a stationary component 125, a movable component 130, and a permanent magnet assembly 310. The rectangular linear actuator 120 operates in much the same way as the cylindrical linear actuator, except for the shape of the movable component 125 and the shape of the permanent magnet assembly 310 (which is similar to permanent magnet assembly 300). That is, the rectangular linear actuator 120 relies on the same principles of interaction between a current flowing on a movable component 110 and a permanent magnetic field, and the above principles will also apply to the rectangular embodiment.

As shown in FIG. 8, the movable component 125 of the rectangular linear actuator 120 has the shape of a hollow rectangular prism. In the embodiment shown, a top surface of the hollow rectangular prism is positioned within a first channel, the first channel formed as a gap between the central core portion and a first arm of the outer hollow portion of the permanent magnet assembly. A bottom surface of the hollow rectangular prism is positioned with a second channel, the second channel formed as a gap between the central core portion and a second arm of the outer hollow portion of the permanent magnet assembly.

In this way, any current which is flowing on either the top surface or the bottom surface of the movable component is configured to interact with the permanent magnetic field which is present within the channels (i.e., the gap regions formed by the permanent magnet assembly). In other words, a conductive pathway exists at least on one surface of the rectangular prism.

This conductive pathway can be formed by at least one conductive winding, which is wound around the surface of the movable component.

Whilst not shown in FIG. 8, the rectangular linear actuator 120 may also have one or more electrical interfaces for delivering the electric current to the movable component, and the electrical interfaces may include one or more flexible conductive bands 150 (which are identical to the flexible conductive bands in the cylindrical linear actuator).

The electrical interface between the stationary component 125 and the movable component 130 may be identical to the electrical interface of the cylindrical linear actuator.

In operation, electrical power (e.g., electric current) is delivered to the movable component 130 from the stationary component 125. Similarly to the cylindrical case, there is a permanent magnet assembly which provides a magnetic field within a gap region 385 so as to interact with the electric current on the movable component.

In the embodiment shown in FIG. 8, the permanent magnet assembly of the rectangular linear actuator 120 comprises a plurality of protrusions 362, 372, both on the core portion (core portion protrusions 362) and on the outer hollow portion (outer hollow portion protrusions 372). It is also envisaged that the protrusions 362, 372 can be present solely on one of the core portion or outer hollow portion. These protrusions serve the same purpose as the protrusions of the cylindrical linear actuator, and so the above principles will apply here also.

In certain embodiment, the cavities, or spaces, between adjacent protrusions 362, 372 on the core portion and the outer hollow portion are at least partially filled with a filler material 365 (e.g., resin). The filler material 365 may be identical to the filler of the cylindrical linear actuator embodiment. In the embodiment shown in FIG. 8, the spaces between the adjacent protrusions are entirely filled, so as to create a smooth channel for the movable component 130.

As shown in FIG. 8, the filler material removes the sharp corners of the protrusions, and it provides smooth channels for the movable component to travel within. If the linear actuator 120 experiences any external forces (e.g., a drop, or a chassis of the linear actuator being hit), then the movable component 130 of said linear actuator will not hit a sharp corner during its motion, thereby improving the robustness of the linear actuator 120.

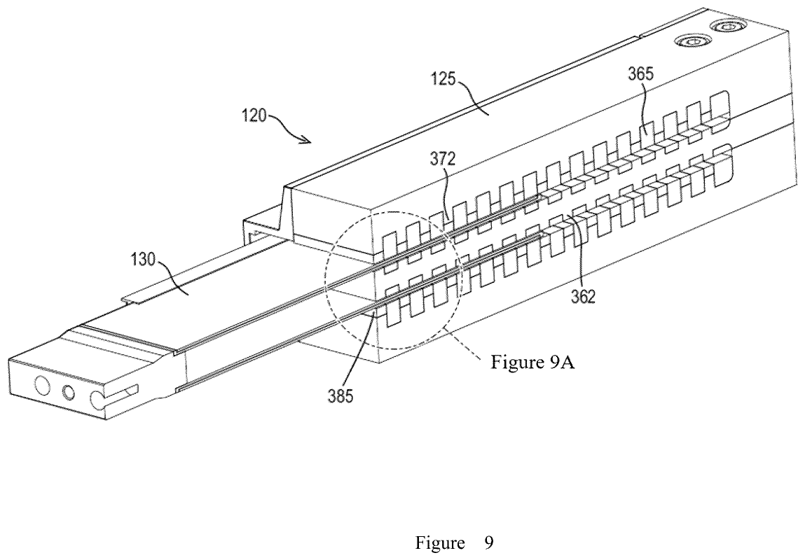

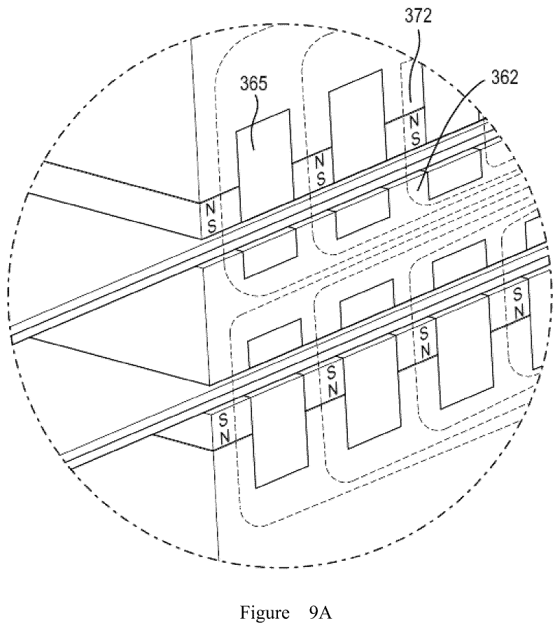

For further detail, a sectioned view of the linear actuator is shown in FIG. 9, and a sub-section view (showing the magnetic flux lines through the movable and stationary components) is given in FIG. 9A.

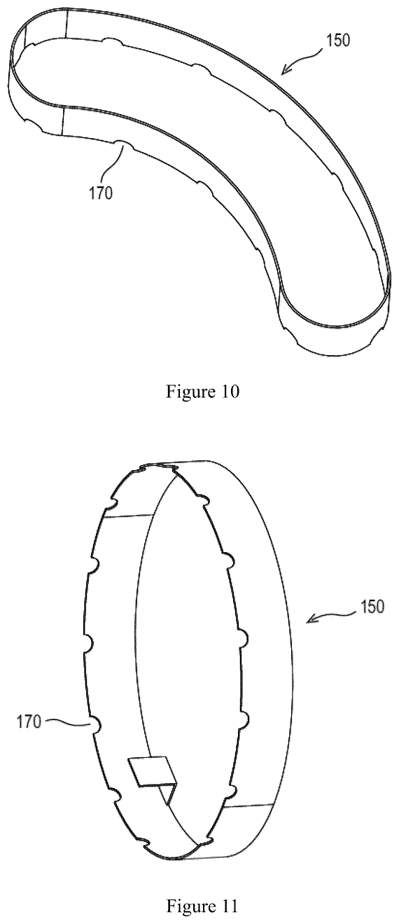

FIGS. 10 and 11 are illustrations of exemplary flexible conductive bands 150 for use in a linear actuator according to embodiments of the present invention.

As shown in these figures, the flexible conductive band 150 may comprise a plurality of notches 170 which can be dispersed around at least one of the edges of the flexible conductive band 150. In some instances, there can be a first plurality of notches 170 along a first edge of the flexible conductive band 150 and a second plurality of notches along a second edge of the flexible conductive band 150.

In some instances, a linear actuator can include features which interact with the notches of the flexible conductive bands, so as to ensure that adjacent flexible conductive bands do not come into contact, and to improve the rolling motion of the flexible conductive bands between the power rails of an electrical interface. However, such features are not necessary.

These flexible conductive bands 150 may be flexible metal foils such as stainless steel that have been coated on at least one side. In some examples, this coating can be Titanium Nitride (which for example can be applied by way of vacuum deposition or sputtering). This coating results in a very low coefficient of friction which further enhances the long term operation on the bands and tracks.

Alternatively, high performance polymeric film materials (such as KAPTON™, which is a type of polyimide plastic film, and PET, or Polyethylene Terephthalate) can be used instead of metal foils. Such a polymeric film can have excellent flexibility and can withstand many flexing and bending cycles without failure. This polyimide film can also be coated with a multitude of highly electrically conductive coatings and finishes like graphene. Then, further coatings can be applied via electroless-plating or electroplating by ion deposition in solution. This allows the application of metals in solution like copper chloride, copper sulphate, nickel, palladium, ruthenium or any other appropriate metal.

The process of adding multiple platings and coating onto flexible plastic substrates can be a very fit for small motors that are mass-produced and can further reduce the dependency of costly metals that are in use today for such motors.

A coating can also be applied to a polymeric film with a liquid based Nano-Silver ink. Such an ink can be deposited by way of ink-jet delivery, or by silk-screen printing or rotogravure printing processes that involve a photo-curable nano-silver oxide ink that instantly changes to a metallic state (via surface reduction) when it comes into contact with a polymer, such as PET (Polyethylene Terephthalate). This conversion from the oxide state to the metallic state (moisture assisted electron conversion) can be used to facilitate a further deposition of an electroless copper (on top of the cured Nano Silver coating) which in turn leads to a very lowcost conductive flexible band or disc for use present invention.

The preceding description has been presented with reference to presently disclosed embodiments of the invention. Workers skilled in the art and technology to which this invention pertains will appreciate that alterations and changes in the described structure may be practiced without meaningfully departing from the principal, spirit and scope of this invention. As understood by one of ordinary skill in the art, the drawings are not necessarily to scale and any feature or combinations of features described in any one embodiment may be incorporated into any other embodiments or combined with any other feature(s) of other embodiments, as desired or needed. Accordingly, the foregoing description should not be read as pertaining only to the precise structures described and illustrated in the accompanying drawings, but rather should be read consistent with and as support to the following claims which are to have their fullest and fair scope.

1. A permanent magnet assembly for a non-commutated linear actuator,
the permanent magnet assembly comprising:
a magnetic core structure, and
a permanent magnet having a first pole and a second pole,
wherein the magnetic core structure comprises a central core portion connected to the first pole of the permanent magnet, an outer hollow portion connected to the second pole of the permanent magnet, and a gap region positioned between the central core portion and the outer hollow portion,
wherein the magnetic core structure is configured such that magnetic flux generated by the permanent magnet flows between the central core portion and the outer hollow portion via the gap region, and
wherein the magnetic core structure comprises one or more protrusions extending into the gap region.

2. The permanent magnet assembly of claim 1,
wherein the one or more protrusions of the magnetic core structure comprise one or more core protrusions, extending radially outwards from the central core portion into the gap region.

3. The permanent magnet assembly of any preceding claim,
wherein the one or more protrusions of the magnetic core structure comprise one or more hollow portion protrusions, extending radially inwards from the outer hollow portion into the gap region.

4. The permanent magnet assembly of claim 3, when dependent on claim 2,
wherein at least one core protrusion of the one or more core protrusions corresponds to, and is aligned with, a respective hollow portion protrusion of the one or more hollow portion protrusions.

5. The permanent magnet assembly of any preceding claim, wherein the central core portion has an axial cross-section which is substantially circular, substantially ovular, or substantially square.

6. The permanent magnet assembly of any preceding claim, wherein the hollow portion has an axial cross-section is substantially circular, substantially ovular, or substantially square, and wherein the outer hollow portion comprises at least one elongated slot along its length, so as to allow access to the gap region.

7. The permanent magnet assembly of any one of claims 2 to 6, wherein the one or more core protrusions has an axial cross-section which substantially circular, substantially ovular, or substantially square.

8. The permanent magnet assembly of any one of claims 3 to 7, wherein the one or more hollow portion protrusions has an axial cross-section is substantially circular, substantially ovular, or substantially square, and wherein the hollow portion protrusion comprises at least one elongated slot along its length, so as to allow access to the gap region.

9. The permanent magnet assembly of any one of claims 3 to 8,
wherein the one or more core protrusions comprises a plurality of core protrusions, and/or
wherein the one or more hollow portion protrusions comprises a plurality of hollow portion protrusions.

10. The permanent magnet assembly of claim 9, wherein each of the plurality of the core protrusions is separated from adjacent core protrusions by a second distance, and wherein each of the plurality of hollow portion protrusions is separated from adjacent hollow portion protrusions by the second distance.

11. The permanent magnet assembly of any one of claims 2 to 9, further comprising a filler material,
wherein the filler material is positioned so as to cover side portions of the one or more protrusions.

12. The permanent magnet assembly of claim 11, when dependent on claim 9 or 10,
wherein the filler material is configured to entirely fill a space between adjacent core protrusions of the plurality of core protrusions, and
wherein the filler material is configured to entirely fill a space between adjacent outer hollow portion protrusions of the plurality of hollow portion protrusions.

13. The permanent magnet assembly of claim 11 or 12, wherein the filler material comprises a resin.

14. A non-commutated linear actuator having a stationary component and a movable component, the movable component configured to move in a longitudinal direction relative to the stationary component,
wherein the stationary component comprises a permanent magnet assembly according to any one of claims 1 to 12, and
wherein the movable component is positioned within the air gap region of the permanent magnet assembly.

15. The non-commutated linear actuator according to claim 14, wherein the movable component comprises at least one conductive winding.

16. The non-commutate linear actuator according to claim 15, wherein the movable component comprises a structure comprising at least one of: carbon fiber, a thermoplastic, a thermoset plastic, or a synthetic fiber material, and wherein the at least one conductive winding is wound around the structure.

17. The non-commutated linear actuator according to claim 15 or 16, when dependent on claim 8, further comprising an electrical interface configured to connect the at least one conductive winding to an electrical power supply through the at least one elongated slot.

18. The non-commutated linear actuator according to claim 17, wherein the electrical interface comprises at least one flexible conductive band configured to transmit electrical power from the electrical power supply to the at least one conductive winding on the movable component.
